(19) United States
(12) Patent Application Publication
(10) Pub. No.: US 2020/0391752 A1
(43) Pub. Date: Dec. 17, 2020

(54) DRIVING ASSISTANCE DEVICE, DRIVING ASSISTANCE METHOD, AND NON-TRANSITORY COMPUTER-READABLE MEDIUM

(71) Applicant: Mitsubishi Electric Corporation, Tokyo (JP)

(72) Inventor: Toshiyuki HAGIWARA, Tokyo (JP)

(73) Assignee: Mitsubishi Electric Corporation, Tokyo (JP)

(21) Appl. No.: 17/006,113

(22) Filed: Aug. 28, 2020

Related U.S. Application Data
(63) Continuation of application No. PCT/JP2018/008182, filed on Mar. 2, 2018.

(51) Int. Cl. B60W 40/08; B60W 40/06; B60W 50/14; G01C 21/36; B60R 11/04; G06K 9/00

(52) U.S. Cl. CPC B60W 40/08; B60W 40/06; B60W 50/14; G01C 21/3667; B60R 11/04; B60R 2300/8086; B60W 2540/229; B60W 2540/225; B60W 2050/143; B60W 2050/146; B60R 2300/105; G06K 9/00845

(57) ABSTRACT

A visual confirmation requiring direction determining unit (110) identifies a traveling direction of a vehicle from a route of the vehicle, and determines a visual confirmation requiring direction corresponding to a category of a branch of a road and a traveling direction of the vehicle, the visual confirmation requiring direction being a direction requiring visual confirmation by a driver of the vehicle. A driver imaging unit (102) captures a driver image. A sight line direction detection unit (103) detects a sight line direction from the driver image, the sight line direction being a direction of a sight line of the driver. An oversight direction judgment unit (111) judges an oversight direction from the visual confirmation requiring direction, the oversight direction being a direction that does not include the sight line direction. An attention calling unit (112) calls attention of the driver to the oversight direction.

### CROSS-REFERENCE TO RELATED APPLICATION

This application is a continuation application of International Application No. PCT/JP2018/008182 having an international filing date of Mar. 2, 2018.

### BACKGROUND OF THE INVENTION

### 1. Field of the Invention

The present disclosure relates to a driving assistance device, a driving assistance method, and a non-transitory computer-readable medium.

### 2. Description of the Related Art

There has been a device having a function of confirming safety around a vehicle by making a navigation screen or the like display an image captured by a camera attached to the outside of the vehicle.

For example, in the Patent Reference 1, a vehicle monitoring device that displays a camera image of the direction corresponding to operation of a turn signal or a steering wheel is disclosed.

Patent Reference 1: Japanese Patent Application Publication No. H7-215130

The conventional technology always displays only an image of a place that requires confirmation irrespective of visual confirming action by a driver.

Thus, it is not considered at all whether a driver is properly seeing the direction to be confirmed, and it is a problem that the conventional technology does not improve safety.

### SUMMARY OF THE INVENTION

Accordingly, an object of one or more modes of the present disclosure is to make it possible to warn a driver that, when the driver misses a direction to be confirmed properly, the driver should confirm the direction.

One mode of the present disclosure provides a driving assistance device including: a map information storing unit configured to store map information; an input unit configured to receive input of a destination; a route search unit configured to search for a route to the destination based on the map information; a vehicle location detection unit configured to detect a vehicle location that is a location of a vehicle; a road state judgment unit configured to judge a road state at the vehicle location based on the map information; a visual confirmation requiring direction determining unit configured, when the road state shows a branch, to identify a category of the branch from the road state, to identify a traveling direction of the vehicle from the route, and to determine a visual confirmation requiring direction corresponding to the identified category and the identified traveling direction, the visual confirmation requiring direction being a direction requiring visual confirmation by a driver of the vehicle; a driver imaging unit configured to capture a driver image that is an image of the driver; a sight line direction detection unit configured to detect a sight line direction from the driver image, the sight line direction being a direction of a sight line of the driver; an oversight direction judgment unit configured to judge an oversight direction from the visual confirmation requiring direction, the oversight direction being a direction that does not include the sight line direction; and an attention calling unit configured to call attention of the driver to the oversight direction.

Another mode of the present disclosure provides a driving assistance method, including: receiving input of a destination; searching for a route to the destination based on a map information; detecting a vehicle location that is a location of a vehicle; judging a road state at the vehicle location based on the map information; when the road state shows a branch, identifying a category of the branch from the road state; identifying a traveling direction of the vehicle from the route; determining a visual confirmation requiring direction corresponding to the identified category and the identified traveling direction, the visual confirmation requiring direction being a direction requiring visual confirmation by a driver of the vehicle; detecting a sight line direction from a driver image that is an image of the driver, the sight line direction being a direction of a sight line of the driver; judging an oversight direction from the visual confirmation requiring direction, the oversight direction being a direction that does not include the sight line direction; and calling attention of the driver to the oversight direction.

According to one or more modes of the present disclosure, it is possible to warn a driver to confirm a direction that the driver should properly confirm when the driver misses the direction.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram showing schematically a configuration of a driving assistance device according to an embodiment 1 of the present invention;

FIG. 2 is a schematic view showing a state of installation of a vehicle surroundings imaging unit;

FIG. 3 is a schematic diagram for explaining a sight line direction of a driver;

FIG. 4 is a schematic diagram showing an example of visual confirmation requiring direction information;

FIG. 5 is a schematic diagram for explaining a relation between a sight line direction and a visual confirmation requiring direction;

FIG. 6 is a block diagram showing an example of hardware configuration;

FIG. 7 is a flowchart showing a flow of processing in a driving assistance device;

FIG. 8 is a schematic diagram showing a state that a vehicle equipped with a driving assistance device is at a T-junction;

FIG. 9 is a flowchart showing processing in an oversight direction judgment unit;

FIG. 10 is a schematic diagram showing an example of a number-of-executed-visual-confirmations table;

FIG. 11 is a block diagram showing schematically a configuration of a driving assistance device according to an embodiment 2 of the present invention;

FIG. 12 is a schematic view showing an example of an image displayed in the embodiment 2;

FIG. 13 is a block diagram showing schematically a configuration of a driving assistance device according to an embodiment 3 of the present invention; and

FIG. 14 is a schematic diagram showing an example of number-of-oversights information.

### DETAILED DESCRIPTION OF THE INVENTION

### Embodiment 1

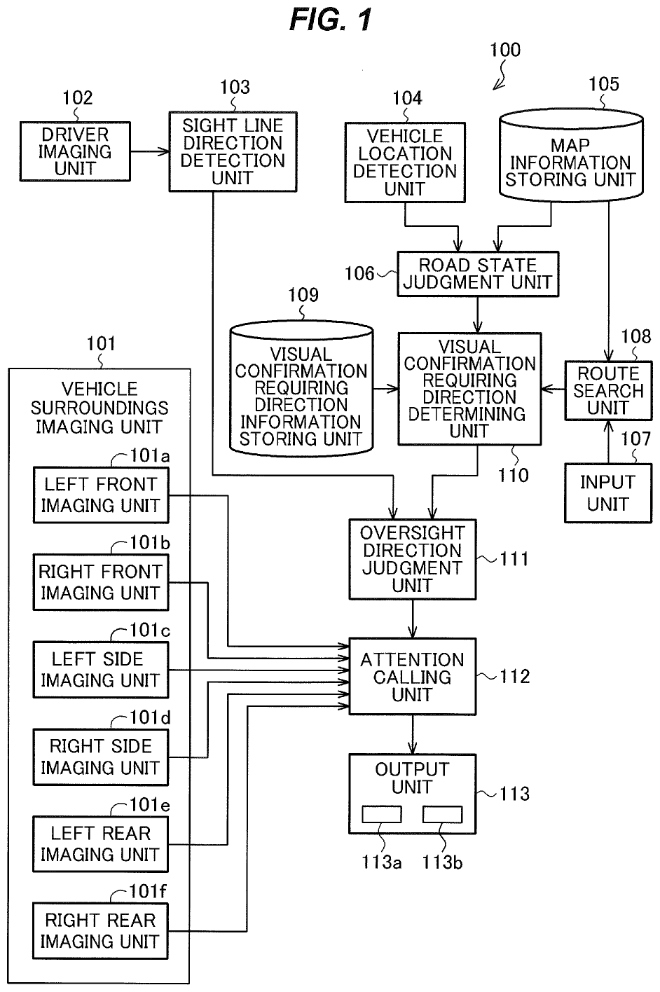

FIG. 1 is a block diagram showing schematically a configuration of a driving assistance device 100 according to an embodiment 1 of the present invention.

The driving assistance device 100 of the embodiment 1 includes a vehicle surroundings imaging unit 101, a driver imaging unit 102, a sight line direction detection unit 103, a vehicle location detection unit 104, a map information storing unit 105, a road state judgment unit 106, an input unit 107, a route search unit 108, a visual confirmation requiring direction information storing unit 109, a visual confirmation requiring direction determining unit 110, an oversight direction judgment unit 111, an attention calling unit 112, and an output unit 113.

The vehicle surroundings imaging unit 101 captures a plurality of images corresponding to a plurality of directions around a vehicle to which the driving assistance device 100 is attached.

The vehicle surroundings imaging unit 101 includes a left front imaging unit 101a, a right front imaging unit 101b, a left side imaging unit 101c, a right side imaging unit 101d, a left rear imaging unit 101e, and a right rear imaging unit 101f.

The left front imaging unit 101a captures an image of the left front direction from the vehicle.

The right front imaging unit 101b captures an image of the right front direction from the vehicle.

The left side imaging unit 101c captures an image of the left side direction from the vehicle.

The right side imaging unit 101d captures an image of the right side direction from the vehicle.

The left rear imaging unit 101e captures an image of the left rear direction from the vehicle.

The right rear imaging unit 101f captures an image of the right rear direction from the vehicle.

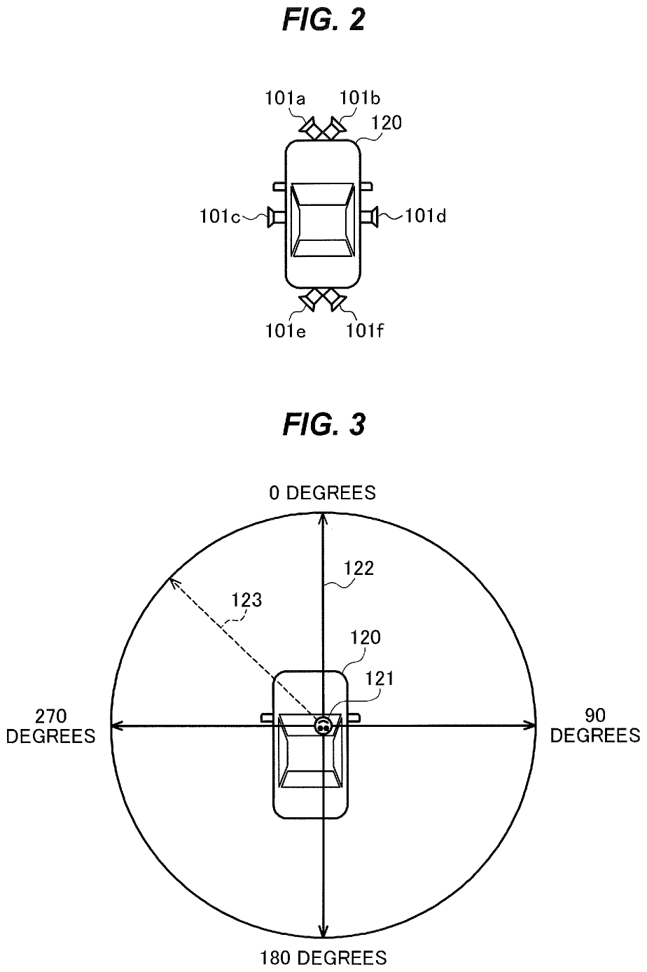

FIG. 2 is a schematic view showing a state of installation of the vehicle surroundings imaging unit 101.

In FIG. 2, it is assumed that the vehicle 120 is equipped with the driving assistance device 100.

The left front imaging unit 101a is installed in the center of the front of the vehicle 120 such that its optical axis is at an angle of 45 degrees to the left with respect to the exact front direction.

The right front imaging unit 101b is installed in the center of the front of the vehicle 120 such that its optical axis is at an angle of 45 degrees to the right with respect to the exact front direction.

The left side imaging unit 101c is installed in the left side of the vehicle 120 such that its optical axis is at an angle of 90 degrees to the left with respect to the exact front direction of the vehicle 120.

The right side imaging unit 101d is installed in the right side of the vehicle 120 such that its optical axis is at an angle of 90 degrees to the right with respect to the exact front direction of the vehicle 120.

The left rear imaging unit 101e is installed in the center of the back of the vehicle 120 such that its optical axis is at an angle of 45 degrees to the right with respect to the exact rear direction of the vehicle 120.

The right rear imaging unit 101f is installed in the center of the back of the vehicle 120 such that its optical axis is at an angle of 45 degrees to the left with respect to the exact rear direction of the vehicle 120.

By arranging these imaging units 101a-101f as shown in FIG. 2, it is possible to capture images without blind spots with respect to the front and rear directions of the vehicle 120 when the horizontal angle of view of each of these imaging units 101a-101f is 90 degrees. Here, the horizontal angle of view is a range of imaging in the horizontal direction.

It is suitable that the optical axes of these imaging units 101a-101f are parallel to the ground.

To return to FIG. 1, the driver imaging unit 102 is installed in the inside of the vehicle 120, and captures a driver image which is an image of a driver of the vehicle 120. In detail, the driver imaging unit 102 captures an image of the face of the driver.

The sight line direction detection unit 103 detects the direction of the face of the driver and the direction of the eyeballs of the driver from the image captured by the driver imaging unit 102, to detect the sight line direction which is the direction of the driver's sight line. Here, the sight line direction detection unit 103 may detect the direction of the driver's sight line by using only the direction of the face of the driver. The sight line direction detection unit 103 gives sight line direction information that indicates the detected sight line direction to the oversight direction judgment unit 111.

FIG. 3 is a schematic diagram for explaining a sight line direction of a driver.

In FIG. 3, a sight line direction is expressed by an angle between the sight line direction 122 in the case where the front of the vehicle 120 is seen from the position of a driver 121 of the vehicle 120 and the sight line direction 123 in which the driver 121 is looking. This angle between the front sight line 122 and the sight line 123 in which the driver 121 is looking is taken as positive when it is measured in the clockwise direction seen from directly above the vehicle 120. Thus, the sight line is 90 degrees when the driver 121 looks at just right side, 180 degrees when the driver 121 looks just behind, and 270 degrees when the driver 121 looks at just left side.

To return to FIG. 1, the vehicle location detection unit 104 detects the vehicle location which is the current location of the vehicle 120, and gives vehicle location information indicating the detected vehicle location to the road state judgment unit 106. The vehicle location information is, for example, information on the latitude and the longitude.

The map information storing unit 105 stores map information. The map information includes point data of a node and a supplementary point, and link data. The node is a branch point such as intersection or a junction. The supplementary point is a point indicating a bend of a road. The point data are location information indicating the locations of the node and the supplementary point. The location information is information on latitude and longitude, for example. The link data are information expressing the relation of connection between nodes.

The point data and the link data have their attribute information. For example, the attribute information of the point data is existence or non-existence of traffic signal, and the like, and the attribute information of the link data is road category, road width, number of lanes, and the like.

The road state judgment unit 106 refers to the map information stored in the map information storing unit 105, to judge the road state at the vehicle's current location indicated by the vehicle location information given from the vehicle location detection unit 104. Here, as the road state, the road state judgment unit 106 judges a category of branch (crossroads, T-junction, interchange exit, or interchange entrance) and existence or non-existence of traffic signal. Then, the road state judgment unit 106 gives road state information indicating the judged road state to the visual confirmation requiring direction determining unit 110.

The input unit 107 receives various kinds of input. For example, the input unit 107 receives input of a location of a departure place and a location of a destination of the vehicle 120.

The route search unit 108 searches for a route to the inputted destination based on the map information stored in the map information storing unit 105. In detail, the route search unit 108 refers to the map information stored in the map information storing unit 105, makes a search for a route of the vehicle 120 based on the inputted location of the departure point and the inputted location of the destination, and generates route information indicating the searched-out route. The route information is information indicating a route for the vehicle 120 to arrive at the destination from the departure point. For example, the route information indicates locations of nodes through which the vehicle 120 passes and a traveling direction at each node. The traveling direction is, for example, left turn, right turn, or straight line.

Although, here, the input unit 107 receives input of a departure point too, input of a departure point is not always necessary. For example, the route search unit 108 may search for a route to a destination by using the vehicle location detected by the vehicle location detection unit 104 as a departure point.

The visual confirmation requiring direction information storing unit 109 stores visual confirmation requiring direction information indicating a visual confirmation requiring direction which is a direction in which a driver needs to confirm safety visually depending on conditions.

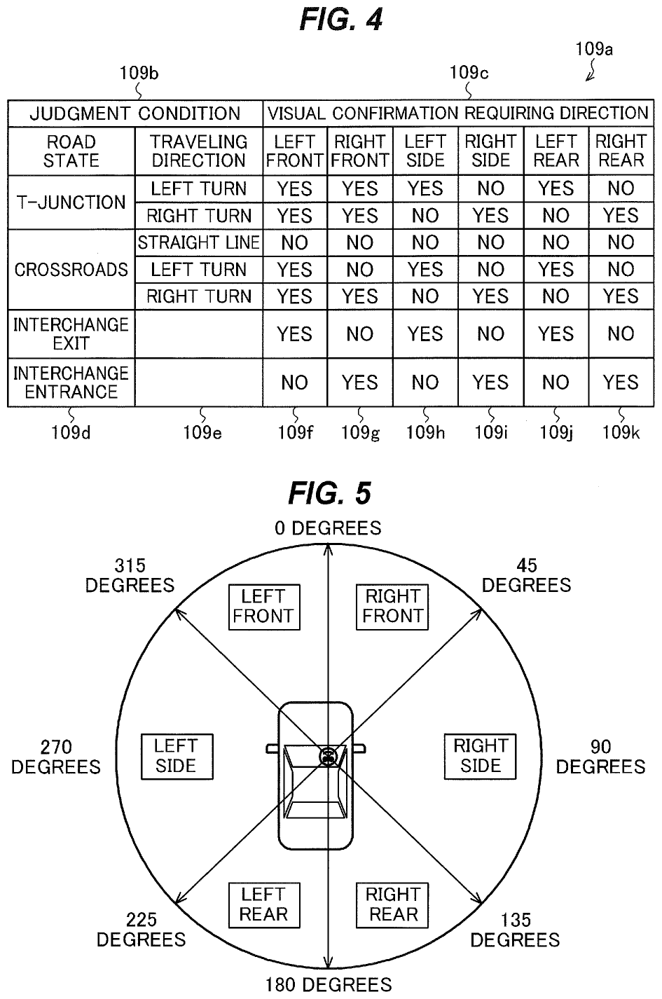

FIG. 4 is a schematic diagram showing a visual confirmation requiring direction table 109a as an example of the visual confirmation requiring direction information.

The visual confirmation requiring direction table 109a has a judgment condition column 109b and a visual confirmation requiring direction column 109c.

The judgment condition column 109b has a road state column 109d and a traveling direction column 109e.

The visual confirmation requiring direction column 109c has a left front column 109f, a right front column 109g, a left side column 109h, a right side column 109i, a left rear column 109j, and a right rear column 109k.

The road state column 109d stores a road state. Here, a category of branch is stored as a road state.

The traveling direction column 109e stores a traveling direction. When the traveling direction column 109e is blank, it indicates that the traveling direction is not defined in the condition, or in other words all the traveling directions satisfy the condition.

The left front column 109f, the right front column 109g, the left side column 109h, the right side column 109i, the left rear column 109j, and the right rear column 109k store whether left front, right front, left side, right side, left rear, and right rear apply to directions requiring visual confirmation or not, respectively.

For example, when “YES” is stored in the left front column 109f, the right front column 109g, the left side column 109h, the right side column 109i, the left rear column 109j, or the right rear column 109k, it indicates that the corresponding direction is a visual confirmation requiring direction in the road state and the traveling direction shown in the same row. On the other hand, when “NO” is stored in the left front column 109f, the right front column 109g, the left side column 109h, the right side column 109i, the left rear column 109j, or the right rear column 109k, it indicates that the corresponding direction is not a visual confirmation requiring direction in the road state and the traveling direction shown in the same row.

In other words, in the visual confirmation requiring direction table 109a shown in FIG. 4, a direction for which “YES” is set in the visual confirmation requiring direction column 109c is a visual confirmation requiring direction when the condition stored in the judgment condition column 109b is satisfied.

Although here the condition includes the road state and the traveling direction, existence or non-existence of traffic signal can be included.

To return to FIG. 1, the visual confirmation requiring direction determining unit 110 refers to the visual confirmation requiring direction information stored in the visual confirmation requiring direction information storing unit 109, to determine, from the route information generated by the route search unit 108 and the road state judged by the road state judgment unit 106, a visual confirmation requiring direction which is a direction in which a driver needs to confirm safety visually. A visual confirmation requiring direction is a direction outside the vehicle and a direction in which it is needed to see for safe driving in order to confirm whether a moving object such as another vehicle or a pedestrian exists. For example, in the case where the road state is T-junction and the traveling direction is right turn, it is necessary to confirm the existence of a moving object coming from left in the crossroad, a moving object coming from right in the crossroad, and a moving object coming from right rear. Thus, left front, right front, and right rear becomes directions requiring visual confirmation.

In detail, when the road state indicates branch, the visual confirmation requiring direction determining unit 110 identifies the category of branch from the road state and the traveling direction of the vehicle from the route of the vehicle, and determines a direction requiring visual confirmation corresponding to the identified category and traveling direction.

The oversight direction judgment unit 111 compares the driver's sight line detected by the sight line direction detection unit 103 with the direction requiring visual confirmation determined by the visual confirmation requiring direction determining unit 110, and judges a direction that does not include the driver's sight line to be an oversight direction out of the direction requiring visual confirmation.

FIG. 5 is a schematic diagram for explaining a relation between a sight line and a visual confirmation requiring direction.

As shown in FIG. 5, in the case where 0 degrees<=a sight line<45 degrees, the sight line is included in the right front visual confirmation requiring direction. In the case where 45 degrees<=a sight line<135 degrees, the sight line is included in the right side visual confirmation requiring direction. In the case where 135 degrees<=a sight line<180 degrees, the sight line is included in the right rear visual confirmation requiring direction. In the case where 180 degrees<=a sight line<225 degrees, the sight line is included in the left rear visual confirmation requiring direction. In the case where 225 degrees<=a sight line<315 degrees, the sight line is included in the left side visual confirmation requiring direction. In the case where 315 degrees<=a sight line<359, the sight line is included in the left front visual confirmation requiring direction.

To return to FIG. 1, the attention calling unit 112 calls attention to an oversight direction judged by the oversight direction judgment unit 111. In other words, the attention calling unit 112 calls driver's attention so as to confirm the oversight direction judged by the oversight direction judgment unit 111.

For example, the attention calling unit 112 makes the output unit 113 display an oversight direction image which is an image corresponding to an oversight direction judged by the oversight direction judgment unit 111 out of a plurality of images captured by the vehicle surroundings imaging unit 101. Further, the attention calling unit 112 makes the output unit 113 output a voice that calls attention to the oversight direction judged by the oversight direction judgment unit 111. In detail, when left front is judged to be an oversight direction, the output unit 113 emits a voice such as “Please pay attention to left front”.

The output unit 113 outputs at least one of an image and a voice according to an instruction from the attention calling unit 112. For example, the output unit 113 includes a voice output unit 113a and a display unit 113b.

The voice output unit 113a outputs a voice to the effect that attention should be paid to an oversight direction, in order to call driver's attention to the oversight direction according to an instruction from the attention calling unit 112.

The display unit 113b displays an oversight direction image, i.e. an image corresponding to an oversight direction, according to an instruction from the attention calling unit 112.

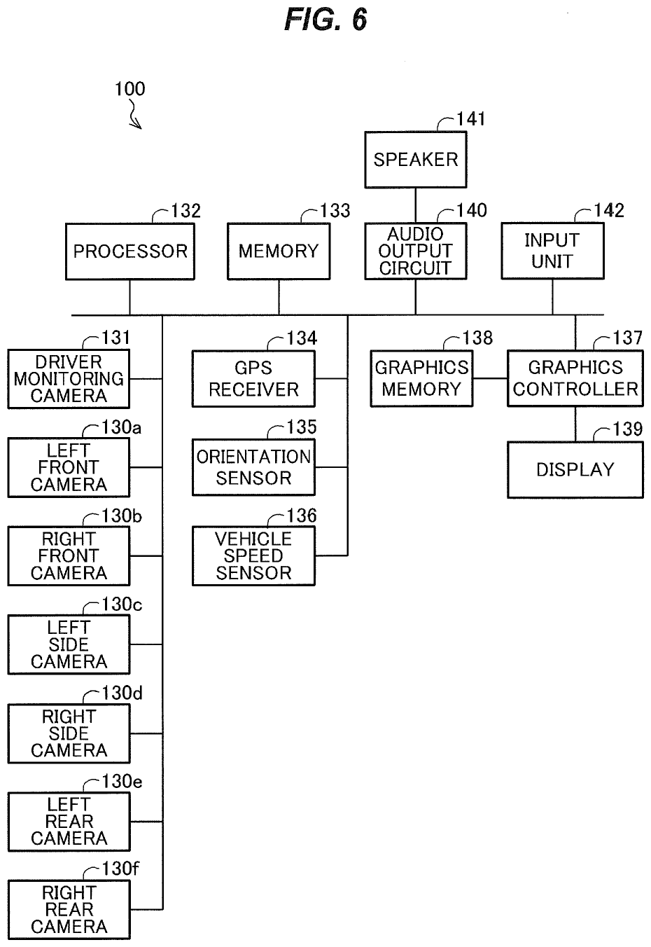

FIG. 6 is a block diagram showing a hardware configuration of the driving assistance device 100 of the embodiment 1.

The driving assistance device 100 includes a left front camera 130a, a right front camera 130b, a left side camera 130c, a right side camera 130d, a left rear camera 130e, a right rear camera 130f, a driver monitoring camera 131, a processor 132, a memory 133, a Global Positioning System (GPS) receiver 134, an orientation sensor 135, a vehicle speed sensor 136, a graphics controller 137, a graphics memory 138, a display 139, an audio output circuit 140, a speaker 141, and an input unit 142.

The left front camera 130a, the right front camera 130b, the left side camera 130c, the right side camera 130d, the left rear camera 130e, the right rear camera 130f, and the driver monitoring camera 131 each capture images.

The processor 132 performs processing in the driving assistance device 100 by executing programs stored in the memory 133.

The memory 133 stores the programs for performing the processing in the driving assistance device 100 and information required for the processing in the driving assistance device 100.

The GPS receiver 134 receives GPS signals sent from a plurality of GPS satellites, in order to detect a location of the vehicle.

The orientation sensor 135 is a device for detecting the direction of the vehicle, such as a gyroscope, for example.

The vehicle speed sensor 136 detects the speed of the vehicle.

Based on an instruction from the processor 132, the graphics controller 137 displays on the display 139 images obtained from the left front imaging unit 101a, the right front imaging unit 101b, the left side imaging unit 101c, the right side imaging unit 101d, the left rear imaging unit 101e, and the right rear imaging unit 101f which are included in the vehicle surroundings imaging unit 101, and generates graphics data of graphics of attention calling information and displays the graphics on the display 139.

The graphics memory 138 stores image data of an image captured by the vehicle surroundings imaging unit 101 and graphics data of graphics generated by the graphics controller 137.

The display 139 is a display device for displaying an image of image data and graphics of graphics data stored in the graphics memory 138. The display 139 is, for example, a liquid-crystal monitor or the like, which is installed in a position that a driver in the vehicle can watch, such as a position in a front meter panel or a center console, for example. Of course, the display 139 is not limited to a liquid-crystal monitor.

The audio output circuit 140 generates an audio signal from audio data. For example, the audio output circuit 140 generates an audio signal from attention-calling audio data stored in the memory 133. The audio data is data representing a voice such as “Left front is not confirmed. Please confirm left front”, for example.

The speaker 141 receives an audio signal generated by the audio output circuit 140 and outputs the voice.

The input unit 142 is a device such as a button for receiving input of an instruction.

When the processor 132 controls the left front camera 130a, the right front camera 130b, the left side camera 130c, the right side camera 130d, the left rear camera 130e, and the right rear camera 130f based on the programs stored in the memory 133, it is possible to implement the left front imaging unit 101a, the right front imaging unit 101b, the left side imaging unit 101c, the right side imaging unit 101d, the left rear imaging unit 101e, and the right rear imaging unit 101f.

When the processor 132 controls the driver monitoring camera 131 based on the programs stored in the memory 133, it is possible to implement the driver imaging unit 102.

When the processor 132 controls the GPS receiver 134, the orientation sensor 135, and the vehicle speed sensor 136 based on the programs stored in the memory 133, it is possible to implement the vehicle location detection unit 104.

When the processor controls the memory 133, it is possible to implement the map information storing unit 105 and the visual confirmation requiring direction information storing unit 109.

When the processor 132 controls the input unit 142 based on the programs stored in the memory 133, it is possible to implement the input unit 107.

When the programs stored in the memory 133 are executed, the sight line direction detection unit 103, the road state judgment unit 106, the route search unit 108, the visual confirmation requiring direction determining unit 110, the oversight direction judgment unit 111, and the attention calling unit 112 are implemented.

When the processor 132 controls the graphics controller 137, the graphics memory 138, the display 139, the audio output circuit 140, and the speaker 141 based on the programs stored in the memory 133, the output unit 113 is implemented.

The above-described programs may be provided through a network, or may be provided with them being stored in a recording medium. The recording medium is, for example, a non-transitory computer-readable storage medium. In other words, these programs may be provided as a program product, for example.

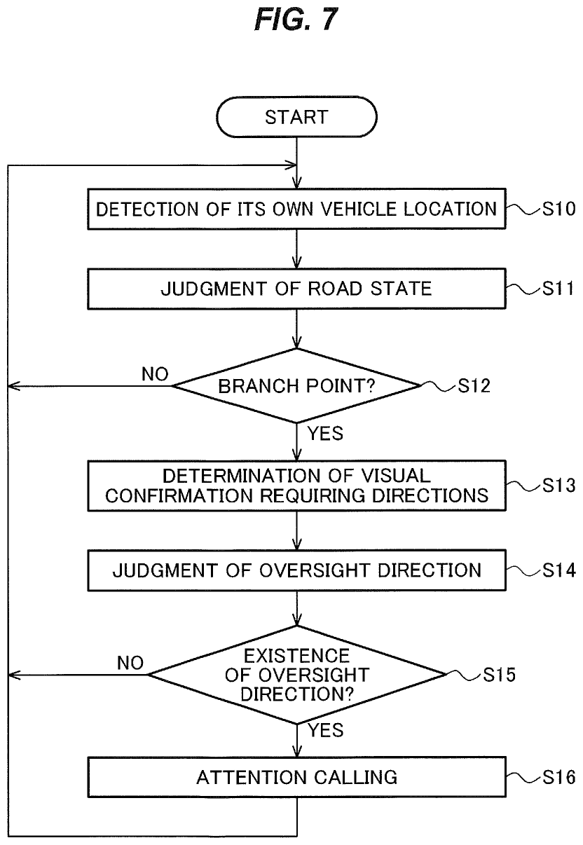

FIG. 7 is a flowchart showing a flow of processing in the driving assistance device 100 of the embodiment 1.

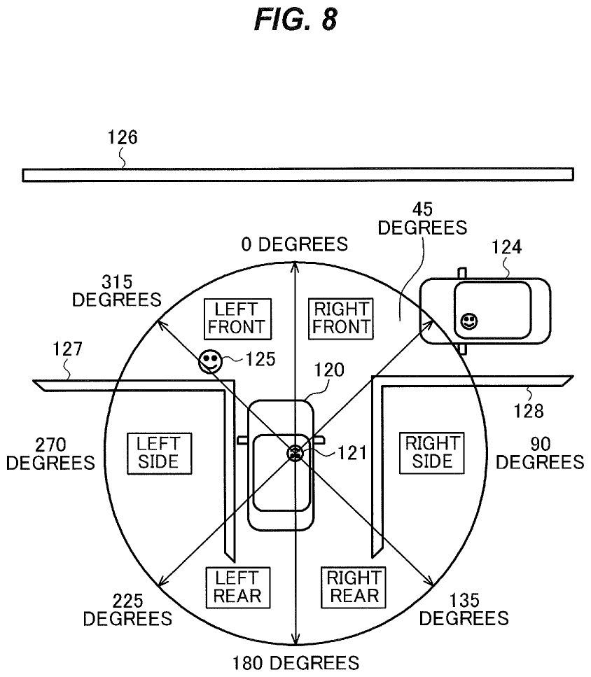

FIG. 8 is a schematic diagram showing a state that a vehicle 120 equipped with the driving assistance device 100 of the embodiment 1 is at a T-junction.

In FIG. 8, the vehicle 120 is stopped temporarily in front of the T-junction. Another vehicle 124 is moving toward the T-junction from the right of the T-junction. A pedestrian 125 is moving toward the T-junction from the left of the T-junction. The T-junction is enclosed by walls 126, 127, and 128, and thereby the view of the driver 121 of the vehicle 120 is hindered.

Referring to FIGS. 7 and 8, the flow of processing in the driving assistance device 100 of the embodiment 1 will be described.

Here, it is assumed that the driver 121 of the vehicle 120 has inputted a departure place and a destination via the input unit 107, and the route search unit 108 has generated rote information indicating a route from the departure place to the destination and given the route information to the visual confirmation requiring direction determining unit 110.

First, to detect the vehicle location, the vehicle location detection unit 104 receives GPS signals from a plurality of GPS satellites, and positions the current location of its own vehicle (S10). Then, the vehicle location detection unit 104 gives information indicating the detected vehicle location as vehicle location information to the road state judgment unit 106.

Next, the road state judgment unit 106 judges the road state of the location in which its own vehicle is positioned based on the vehicle location information and the map information stored in the map information storing unit 105 (S11). Then, the road state judgment unit 106 gives the road state information indicating the judged road state to the visual confirmation requiring direction determining unit 110.

Next, the visual confirmation requiring direction determining unit 110 judges whether the location in which the vehicle 120 is positioned is a branch point or not, based on the road state information given from the road state judgment unit 106 (S12). Branch point is, for example, T-junction, crossroads, interchange exit, or interchange entrance. In the case where the location of the vehicle 120 is a branch point (Yes in S12), the processing proceeds to the step S13. In the case where the location of the vehicle 120 is not a branch point (No in S12), the processing returns to the step S10.

Next, the visual confirmation requiring direction determining unit 110 determines visual confirmation requiring directions based on the road state information and the route information (S13). For example, in the case where the road state is T-junction as shown in FIG. 8 and the traveling direction is right turn, the visual confirmation requiring direction determining unit 110 judges that the visual confirmation requiring directions are left front, right front, right side, and right rear based on the visual confirmation requiring direction table 109a shown in FIG. 4.

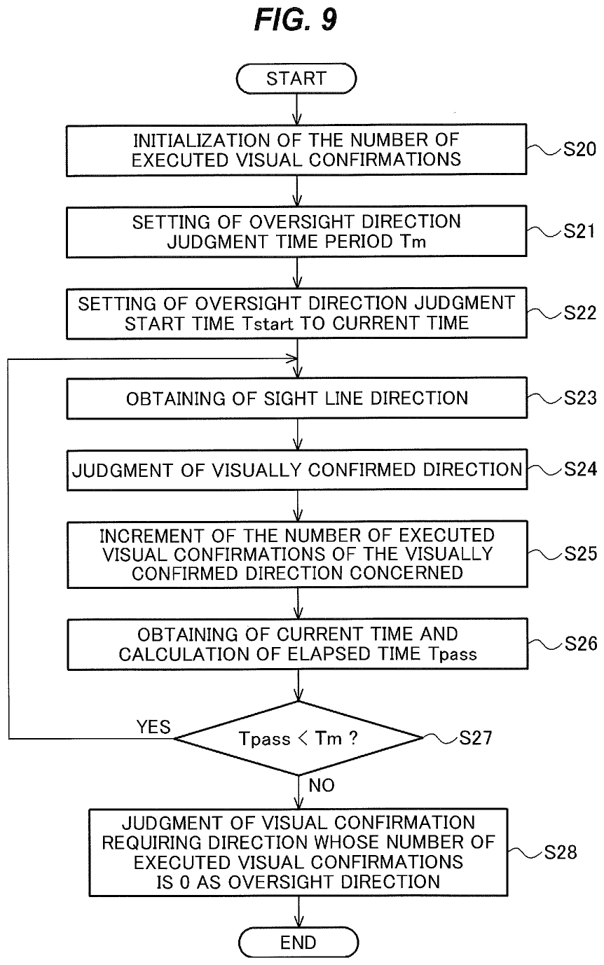

Next, the oversight direction judgment unit 111 judges an oversight direction, based on the sight line direction information indicating the sight line of the driver, which is obtained from the sight line direction detection unit 103, the route information obtained from the route search unit 108, and the visual confirmation requiring direction information obtained from the visual confirmation requiring direction determining unit 110. The processing of judging an oversight direction will be described later referring to FIG. 9.

Next, the oversight direction judgment unit 111 judges whether an oversight direction exists or not (S15). In the case where an oversight direction exists (Yes in S15), the processing proceeds to the step S16; in the case where an oversight direction does not exist (No in S15), the processing returns to the step S10.

Here, in the case where an oversight direction exists, the oversight direction judgment unit 111 gives oversight direction information indicating the oversight direction to the attention calling unit 112.

Next, the attention calling unit 112 calls attention based on the oversight direction information (S16). For example, the attention calling unit 112 outputs a voice giving notice of the oversight direction via the output unit 113 by using previously-prepared voice data.

In detail, in the case where the oversight direction information indicates left front, the following voice is outputted. “Left front is not confirmed. Please pay attention”.

Alternatively, the attention calling unit 112 may display the image of the oversight direction on the output unit 113.

Alternatively, the attention calling unit 112 may make the output unit 113 output both the voice and image.

FIG. 9 is a flowchart showing processing in the oversight direction judgment unit 111.

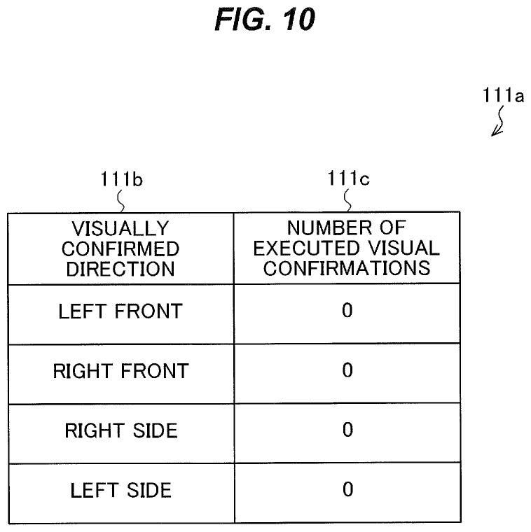

First, the oversight direction judgment unit 111 initializes to zero the number of executed visual confirmations of each visual confirmation requiring direction indicated in the visual confirmation requiring direction information given from the visual confirmation requiring direction determining unit 110 (S20). In detail, the oversight direction judgment unit 111 generates a number-of-executed-visual-confirmations table 111a as shown in FIG. 10 based on the visual confirmation requiring direction information given from the visual confirmation requiring direction determining unit 110.

The number-of-executed-visual-confirmations table 111a has a visually confirmed direction column 111b and a number-of-executed-visual-confirmations column 111c.

Each row of the visually confirmed direction column 111b stores, as a visually confirmed direction, each of the visual confirmation requiring directions indicated in the visual confirmation requiring direction information given from the visual confirmation requiring direction determining unit 110. FIG. 10 shows an example in which the visual confirmation requiring directions indicated in the visual confirmation requiring direction information are left front, right front, right side, and right rear.

Each row of the number-of-executed-visual-confirmations column 111c stores the number of visual confirmations executed in the visually confirmed direction stored in the same row.

To return to FIG. 9, the oversight direction judgment unit 111 sets an oversight direction judgment time length Tm (S21). The oversight direction judgment time length Tm is a time length for which a driver carries out visual confirmation, for example, and is previously determined.

Next, the oversight direction judgment unit 111 sets an oversight direction judgment start time Tstart to the current time (S22).

Next, the oversight direction judgment unit 111 obtains the sight line direction information from the sight line direction detection unit 103 (S23).

Next, the oversight direction judgment unit 111 judges a visually confirmed direction based on the sight line direction indicated in the sight line direction information (S24). Judgment of the visually confirmed direction is similar to the judgment of the visual confirmation requiring direction, which has been described referring to FIG. 5. For example, in the case where the sight line direction is 30 degrees, the visually confirmed direction is judged to be right front as shown in FIG. 5.

Next, the oversight direction judgment unit 111 adds “1” to the number of executed visual confirmations of the corresponding visually confirmed direction of the number-of-executed-visual-confirmations table 111a (S25). For example, in the case where the visually confirmed direction is judged to be right front, “1” is added to the number of executed visual confirmations of right front.

Next, the oversight direction judgment unit 111 obtains a current time Tnow, and calculates an elapsed time Tpass from the oversight direction judgment start time, based of a difference between the current time Tnow and the oversight direction judgment start time Tstart (S26).

Next, the oversight direction judgment unit 111 compares the elapsed time Tpass with the oversight direction judgment time length Tm, to judge whether the elapsed time Tpass is less than the oversight direction judgment time length Tm or not (S27). In the case where the elapsed time Tpass is less than the oversight direction judgment time length Tm (Yes in S27), the processing returns to the step S23; in the case where the elapsed time Tpass is larger than or equal to the oversight direction judgment time length Tm (No in S27), the processing proceeds to the step S28.

In the step S28, the oversight direction judgment unit 111 refers to the number-of-executed-visual-confirmations table 111a, and judges a visual confirmation requiring direction whose number of executed visual confirmations is “0” to be an oversight direction.

As described above, according to the embodiment 1, it is possible to prevent an oversight and to improve safety by judging whether the driver of the vehicle is seeing in the direction to be confirmed for safety and by calling attention to an oversight direction by means of at least one of image and voice if the driver is not seeing.

### Embodiment 2

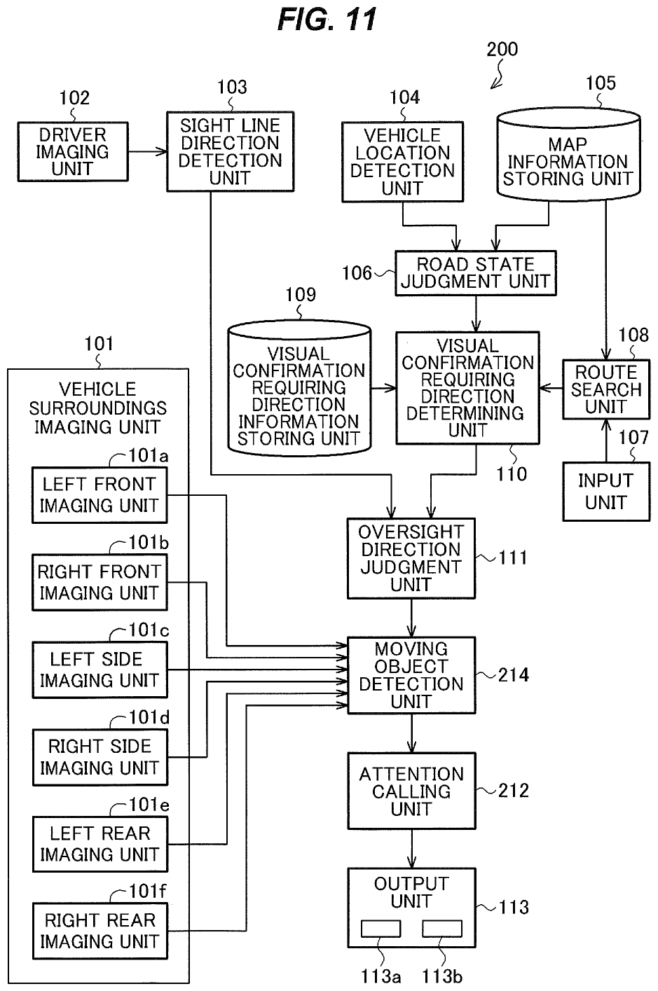

FIG. 11 is a block diagram showing schematically a configuration of a driving assistance device 200 according to an embodiment 2.

The driving assistance device 200 of the embodiment 2 includes a vehicle surroundings imaging unit 101, a driver imaging unit 102, a sight line direction detection unit 103, a vehicle location detection unit 104, a map information storing unit 105, a road state judgment unit 106, an input unit 107, a route search unit 108, a visual confirmation requiring direction information storing unit 109, a visual confirmation requiring direction determining unit 110, an oversight direction judgment unit 111, an attention calling unit 212, an output unit 113, and a moving object detection unit 214.

In the embodiment 2, the vehicle surroundings imaging unit 101, the driver imaging unit 102, the sight line direction detection unit 103, the vehicle location detection unit 104, the map information storing unit 105, the road state judgment unit 106, the input unit 107, the route search unit 108, the visual confirmation requiring direction information storing unit 109, the visual confirmation requiring direction determining unit 110, the oversight direction judgment unit 111, and the output unit 113 are the same as the corresponding units in the embodiment 1.

However, the oversight direction judgment unit 111 gives the oversight direction information indicating oversight directions to the moving object detection unit 214.

The moving object detection unit 214 detects a moving object from an image captured by the vehicle surroundings imaging unit 101 in all the oversight directions indicated in the oversight direction information given from the oversight direction judgment unit 111, and then gives, as attention calling information, moving object detection information indicating the detected moving object and the oversight direction information to the attention calling unit 212. Detection of a moving object can be performed, for example, by image matching or the like. The moving object detection information is information indicating oversight direction in which a moving object is detected, the number of moving objects in an image captured in each oversight direction, and a location and a size of each moving object, for example.

Further, the moving object detection unit 214 gives the attention calling unit 212 image data of an image corresponding to each oversight direction.

The attention calling unit 212 calls attention to an oversight direction in which a moving object has been detected based on the attention calling information given from the moving object detection unit 214.

For example, the attention calling unit 212 uses a voice to call attention to an oversight direction in which a moving object has been detected, based on the attention calling information given from the moving object detection unit 214. In detail, the attention calling unit 212 can select voice data corresponding to a detected oversight direction in which a moving object has been detected out of attention-calling voice data previously prepared for each of the oversight directions, and makes the voice output unit 113a output a voice corresponding to the voice data by giving the selected voice data to the output unit 113. Here, it may be possible to output a voice of the effect that attention should be paid to a moving object. For example, in the case where left rear is an oversight direction in which a moving object has been detected, the voice output unit 113a outputs a voice “A moving object exists in left rear. Please pay attention”. In such a case, the moving object detection unit 214 may give, as the attention calling information, moving object detection information indicating the oversight direction in which the moving object has been detected to the attention calling unit 212. Further, similarly to the embodiment 1, the attention calling unit 212 may make the voice output unit 113a output a voice that calls attention to the oversight direction as well. Further, the attention calling unit 212 may add at least one of the number, location, and size of the detected moving object to a voice outputted from the output unit 113.

In addition, based on the attention calling information given from the moving object detection unit 214, the attention calling unit 212 may call attention by using an image and a voice with respect to an oversight direction in which a moving object has been detected. In detail, from the moving object detection unit 214, the attention calling unit 212 obtains image data of an image of an oversight direction in which a moving object has been detected. Then, the attention calling unit 212 determines the position and the size of each moving object from the moving object detection information, and writes a frame of the determined size at the determined position over the obtained image data. The attention calling unit 212 gives the image data with the written frame to the output unit 113. Thereby, the display unit 113b can display the moving object with the frame being added at the position of the moving object.

The image data of the oversight direction may be included in the attention calling information.

Although, here, each moving object is indicated by a frame, each moving object may be indicated by an arrow, for example. In other words, it is possible to use any display method that can specifically indicate a moving object in an image.

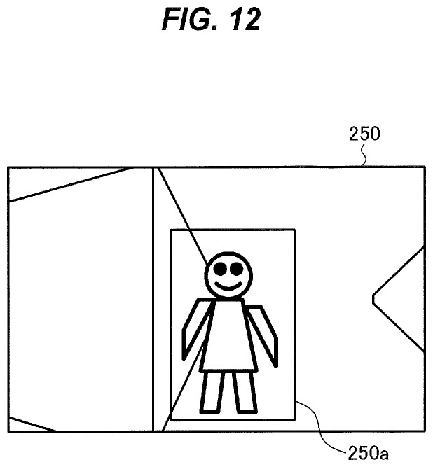

FIG. 12 is a schematic view showing an example of an image displayed in the embodiment 2.

In FIG. 12, in the case where a man is walking from left front of a T-junction, the moving object detection unit 214 detects the man and gives, as the moving object detection information, information indicating the position and the size of the man to the attention calling unit 212. The attention calling unit 212 adds a frame 250a to the image 250 based on the information indicating the position and the size of the man. At the same time, concerning a voice, the attention calling unit 212 selects voice data of a voice for calling attention out of previously-prepared voice data for oversight directions and gives the selected voice data to the output unit 113. In the case where the oversight direction is left front, a voice “A moving object exists in left front. Please confirm” is outputted from the output unit 113.

As described above, according to the embodiment 2, it is judged whether the driver is seeing in the direction that should be confirmed for safety. In the case where the driver is not seeing in that direction, a moving object in that direction is detected. When an moving object is detected, attention is called to the detected moving object. This has the effect of preventing an oversight and improving safety. Further, since detection is not performed with respect to a moving object in the direction in which the driver is seeing, it is possible to reduce load on the driving assistance device 200. Further, since detection is not performed with respect to a moving object in the direction in which the driver does not need to see, it is possible to reduce load on the driving assistance device 200.

### Embodiment 3

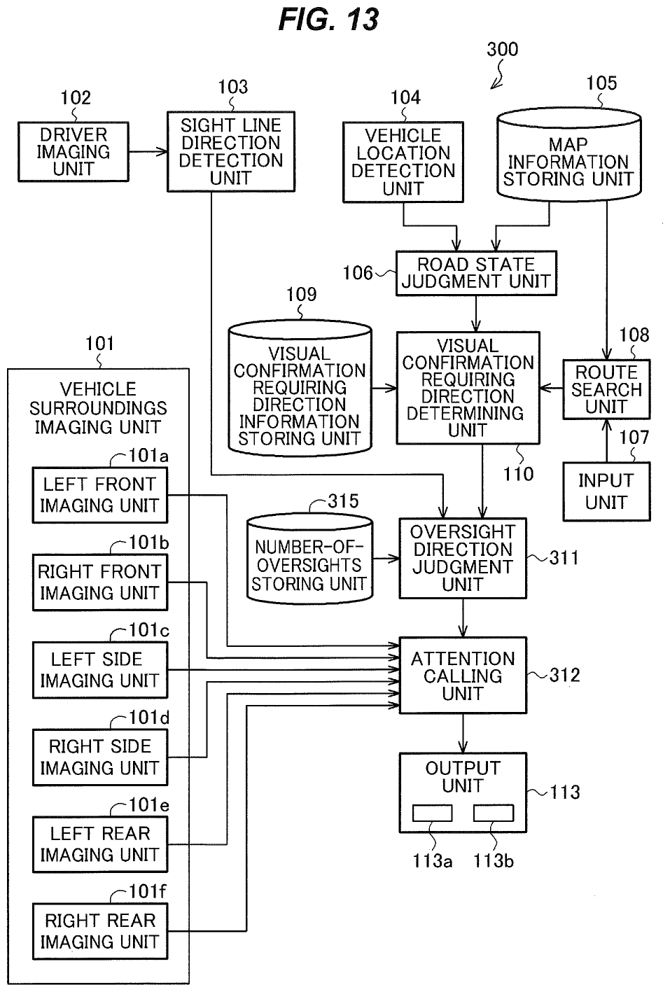

FIG. 13 is a block diagram showing schematically a configuration of a driving assistance device 300 according to an embodiment 3.

The driving assistance device 300 of the embodiment 3 includes a vehicle surroundings imaging unit 101, a driver imaging unit 102, a sight line direction detection unit 103, a vehicle location detection unit 104, a map information storing unit 105, a road state judgment unit 106, an input unit 107, a route search unit 108, a visual confirmation requiring direction information storing unit 109, a visual confirmation requiring direction determining unit 110, an oversight direction judgment unit 311, an attention calling unit 312, an output unit 113, and a number-of-oversights storing unit 315.

In the embodiment 3, the vehicle surroundings imaging unit 101, the driver imaging unit 102, the sight line direction detection unit 103, the vehicle location detection unit 104, the map information storing unit 105, the road state judgment unit 106, the input unit 107, the route search unit 108, the visual confirmation requiring direction information storing unit 109, the visual confirmation requiring direction determining unit 110, and the output unit 113 are the same as the corresponding units in the embodiment 1.

The number-of-oversights storing unit 315 stores number-of-oversights information indicating the number of judgments of oversight direction made until now for each direction requiring visual confirmation corresponding to a combination of a category of branch and a traveling direction.

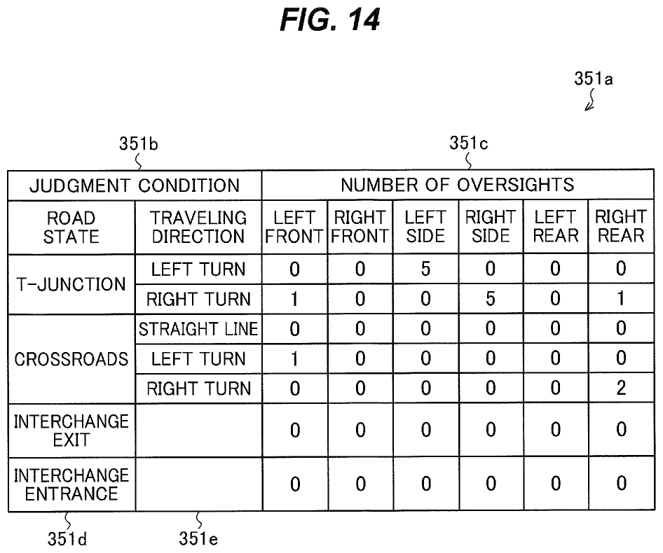

FIG. 14 is a schematic diagram showing a number-of-oversights table 351a as an example of the number-of-oversights information.

The number-of-oversights table 351a has a judgment condition column 351b and a number-of-oversights column 351c.

The judgment condition column 351b has a road state column 351d and a traveling direction column 351e.

The number-of-oversights column 351c has a left front column 351f, a right front column 351g, a left side column 351h, a right side column 351i, a left rear column 351j, and a right rear column 351k.

The road state column 351d stores a road state. Here, a category of branch is stored.

The traveling direction column 351e stores a traveling direction. When the traveling direction column 351e is blank, it indicates that a traveling direction is not defined in the condition, or in other words all the traveling directions satisfy the condition.

Each of the left front column 351f, the right front column 351g, the left side column 351h, the right side column 351i, the left rear column 351j, and the right rear column 351k stores the number of oversights.

For example, in the case where “1” is stored in the left front column 351f in the row in which the road state column 351d is “T-junction” and the traveling direction column 351e is “left turn”, it indicates that, in this condition, the number of times of judging the left front to be an oversight direction is “1”.

Although here the judgment condition includes the road state and the traveling direction, existence or non-existence of traffic signal can be included.

Based on the road state, the traveling direction, the visual confirmation requiring directions, and the number-of-oversights information stored in the number-of-oversights storing unit 315, the oversight direction judgment unit 311 gives advance attention calling oversight direction information, to the attention calling unit 312 before the judgment of oversight direction. The advance attention calling oversight direction information is information indicating visual confirmation requiring directions in which the number of oversights is larger than or equal to a predetermined threshold from all the visual confirmation requiring directions. Here, the prescribed threshold may be, for example, “3”.

Thereafter, similarly to the embodiment 1, the oversight direction judgment unit 311 identifies a driver's sight line direction for a predetermined period of time to judge oversight directions, and adds “1” to the number of oversights for each of the judged oversight directions in the number-of-oversights information.

For example, based on the vehicle location information of the vehicle location detection unit 104 and the map information held by the map information storing unit 105, the road state judgment unit 106 judges that the vehicle is at a T-junction.

Next, the visual confirmation requiring direction determining unit 110 obtains the traveling direction based on the road state and the route information held by the route search unit 108, and determines visual confirmation requiring directions. For example, in the case where the road state is T-junction and the traveling direction is right turn, the visual confirmation requiring directions become left front, right front, right side, and right rear from the visual confirmation requiring direction table 109a shown in FIG. 4.

Next, based on the road state, the traveling direction, and the visual confirmation requiring directions, the oversight direction judgment unit 311 identifies the number of oversights for each visual confirmation requiring direction from the number-of-oversights table 351a, and judges whether the number of oversights is larger than or equal to 3 for each visual confirmation requiring direction. As a result, since the number of oversights for left front is 5, which is larger than 3, the advance attention calling oversight direction information that indicates left front as advance attention calling oversight direction is given to the attention calling unit 312.

The attention calling unit 312 notifies the driver that attention should be paid to the advance attention calling oversight direction indicated in the advance attention calling oversight direction information. For example, the attention calling unit 312 calls driver's attention by notifying the driver of left front as the advance attention calling oversight direction by using the previously-prepared voice data. For example, in the case where the advance attention calling oversight direction is left front, the output unit 113 outputs the voice “Please pay attention to left front”.

Otherwise, the attention calling unit 312 may make the output unit 113 display an image based on the image data from the left front imaging unit 101a that is capturing an image of left front.

Further, the attention calling unit 312 may make the output unit 113 output both the voice and the image mentioned above.

As described hereinabove, according to the embodiment 3, when the number of past oversights of a direction is large, it is possible to notify in advance the driver of the direction as an easily-missed direction and thus to prevent oversight when visual confirmation should be performed.

### DESCRIPTION OF REFERENCE CHARACTERS

100, 200, 300: driving assistance device; 101: vehicle surroundings imaging unit; 102: driver imaging unit; 103: sight line direction detection unit; 104: vehicle location detection unit; 105: map information storing unit; 106: road state judgment unit; 107: input unit; 108: route search unit; 109: visual confirmation requiring direction information storing unit; 110: visual confirmation requiring direction determining unit; 111, 311: oversight direction judgment unit; 112, 212, 312: attention calling unit; 113: output unit; 113a: voice output unit; 113b: display unit; 214: moving object detection unit; and 315: number-of-oversights storing unit.

What is claimed is:

1. A driving assistance device, comprising:
a driver monitoring camera to capture a driver image that is an image of a driver of a vehicle;
a plurality of cameras to capture a plurality of images corresponding to a plurality of directions around the vehicle;
a display to display an image;
a processor to execute a program; and
a memory to store map information and the program which, when executed by the processor, performs processes of,
receiving input of a destination;
searching for a route to the destination based on the map information;
detecting a vehicle location that is a location of the vehicle;
judging a road state at the vehicle location based on the map information;
when the road state shows a branch, identifying a category of the branch from the road state;
identifying a traveling direction of the vehicle from the route;
determining a visual confirmation requiring direction corresponding to the identified category and the identified traveling direction, the visual confirmation requiring direction being a direction requiring visual confirmation by the driver;
detecting a sight line direction from the driver image, the sight line direction being a direction of a sight line of the driver;
judging an oversight direction from the visual confirmation requiring direction, the oversight direction being a direction that does not include the sight line direction; and
calling attention of the driver to the oversight direction,
wherein the display displays an oversight direction image that is an image corresponding to the oversight direction out of the plurality of images, in response to an instruction from the processor.

2. A driving assistance device of claim 1, further comprising:
a speaker to output a voice to the driver in order to call attention to the oversight direction, in response to an instruction from the processor, the voice having an effect that attention should be paid to the oversight direction.

3. A driving assistance device of claim 1,
wherein the processor detects a moving object that is moving in the oversight direction image; and
wherein the display adds an image indicating the moving object, and displays the oversight direction image to which the image indicating the moving object is added.

4. A driving assistance device of claim 3, wherein:
as the image, the display displays a frame at a position corresponding to the moving object.

5. A driving assistance device of claim 3, further comprising a speaker, in response to an instruction from the processor, to output a voice having an effect that attention should be paid to the moving object.

6. A driving assistance device of claim 4, further comprising a speaker, in response to an instruction from the processor, to output a voice having an effect that attention should be paid to the moving object.

7. A driving assistance device of claim 1,
wherein the memory to store a number of judgments of direction as oversight direction for each visual confirmation requiring direction corresponding to each combination of one of a plurality of categories of the branch and one of a plurality of traveling directions; and
wherein, if the number for a visual confirmation requiring direction corresponding to the identified category and the identified traveling direction is more than or equal to a predetermine threshold, the processor, before calling attention to the oversight direction, notifies the driver that attention should be paid to an advance attention calling oversight direction, the advance attention calling oversight direction being the visual confirmation requiring direction for which the number is more than or equal to the predetermined threshold.

8. A driving assistance device of claim 2,
wherein the memory stores a number of judgments of direction as oversight direction for each visual confirmation requiring direction corresponding to each combination of one of a plurality of categories of the branch and one of a plurality of traveling directions;
wherein, if the number for a visual confirmation requiring direction corresponding to the identified category and the identified traveling direction is more than or equal to a predetermine threshold, the processor, before calling attention to the oversight direction, notifies the driver that attention should be paid to an advance attention calling oversight direction, the advance attention calling oversight direction being the visual confirmation requiring direction for which the number is more than or equal to the predetermined threshold.

9. A driving assistance device of claim 3,
wherein the memory stores a number of judgments of direction as oversight direction for each visual confirmation requiring direction corresponding to each combination of one of a plurality of categories of the branch and one of a plurality of traveling directions;
wherein, if the number for a visual confirmation requiring direction corresponding to the identified category and the identified traveling direction is more than or equal to a predetermine threshold, the processor, before calling attention to the oversight direction, notifies the driver that attention should be paid to an advance attention calling oversight direction, the advance attention calling oversight direction being the visual confirmation requiring direction for which the number is more than or equal to the predetermined threshold.

10. A driving assistance device of claim 4,
wherein the memory stores a number of judgments of direction as oversight direction for each visual confirmation requiring direction corresponding to each combination of one of a plurality of categories of the branch and one of a plurality of traveling directions;
wherein, if the number for a visual confirmation requiring direction corresponding to the identified category and the identified traveling direction is more than or equal to a predetermine threshold, the processor, before calling attention to the oversight direction, notifies the driver that attention should be paid to an advance attention calling oversight direction, the advance attention calling oversight direction being the visual confirmation requiring direction for which the number is more than or equal to the predetermined threshold.

11. A driving assistance device of claim 5,
wherein the memory stores a number of judgments of direction as oversight direction for each visual confirmation requiring direction corresponding to each combination of one of a plurality of categories of the branch and one of a plurality of traveling directions;
wherein, if the number for a visual confirmation requiring direction corresponding to the identified category and the identified traveling direction is more than or equal to a predetermine threshold, the processor, before calling attention to the oversight direction, notifies the driver that attention should be paid to an advance attention calling oversight direction, the advance attention calling oversight direction being the visual confirmation requiring direction for which the number is more than or equal to the predetermined threshold.

12. A driving assistance method, comprising:
receiving input of a destination;
searching for a route to the destination based on a map information;
detecting a vehicle location that is a location of a vehicle;
judging a road state at the vehicle location based on the map information;
when the road state shows a branch, identifying a category of the branch from the road state;
identifying a traveling direction of the vehicle from the route;
determining a visual confirmation requiring direction corresponding to the identified category and the identified traveling direction, the visual confirmation requiring direction being a direction requiring visual confirmation by a driver of the vehicle;
detecting a sight line direction from a driver image that is an image of the driver, the sight line direction being a direction of a sight line of the driver;
judging an oversight direction from the visual confirmation requiring direction, the oversight direction being a direction that does not include the sight line direction;
calling attention of the driver to the oversight direction;
capturing a plurality of images corresponding to a plurality of directions around the vehicle; and
displaying an oversight direction image that is an image corresponding to the oversight direction out of the plurality of images.

13. A non-transitory computer-readable medium that stores therein a program causing a computer to execute processes of:
receiving input of a destination;
searching for a route to the destination based on map information;
detecting a vehicle location that is a location of a vehicle;
judging a road state at the vehicle location based on the map information;
when the road state shows a branch, identifying a category of the branch from the road state;
identifying a traveling direction of the vehicle from the route;
determining a visual confirmation requiring direction corresponding to the identified category and the identified traveling direction, the visual confirmation requiring direction being a direction requiring visual confirmation by a driver of the vehicle;
detecting a sight line direction from a driver image that is an image of the driver, the sight line direction being a direction of a sight line of the driver;
judging an oversight direction from the visual confirmation requiring direction, the oversight direction being a direction that does not include the sight line direction;
calling attention of the driver to the oversight direction; and
displaying an oversight direction image that is an image corresponding to the oversight direction out of a plurality of images corresponding to a plurality of directions around the vehicle, in response to an instruction.
